(19) United States
(12) Patent Application Publication
(10) Pub. No.: US 2013/0182277 A1
(43) Pub. Date: Jul. 18, 2013

(54) INFORMATION PROCESSING APPARATUS, CONTROL METHOD THEREFOR, AND STORAGE MEDIUM

(71) Applicant: CANON KABUSHIKI KAISHA, Tokyo (JP)

(72) Inventor: Junji Iguchi, Yokohama-shi (JP)

(73) Assignee: CANON KABUSHIKI KAISHA, Tokyo (JP)

(21) Appl. No.: 13/689,302

(22) Filed: Nov. 29, 2012

(30) Foreign Application Priority Data
Jan. 16, 2012 (JP) 2012-006556

(51) Int. Cl. G06K 15/02

(52) U.S. Cl. CPC G06K 15/02
USPC 358/1.14; 358/1.15

(57) ABSTRACT

There are provided an information processing apparatus which enables a mobile terminal device to send a print instruction to a printer without adding a dedicated arrangement to the printer, a control method for the information processing apparatus, and a program. To accomplish this, an information processing apparatus communicable with a mobile terminal device and an image forming apparatus receives e-mail from the mobile terminal device, analyzes the e-mail received by the reception unit, and transmits, if the e-mail has an attached file and a print instruction is described in the body field of the e-mail in accordance with an analysis result, image data attached to the e-mail while sending a print instruction to an image forming apparatus designated in the subject field or body field of the e-mail.

### BACKGROUND OF THE INVENTION

1. Field of the Invention

The present invention relates to an information processing apparatus for causing a printer to execute print processing in response to a print instruction sent from a mobile terminal device using an e-mail system, a control method for the information processing apparatus, and a storage medium.

2. Description of the Related Art

Japanese Patent Laid-Open No. 2004-220606 proposes a technique of attaching a file to be printed to e-mail and then transmitting the e-mail from the e-mail software of a mobile terminal device to a printer in a print system. In this technique, an e-mail address is assigned to the printer in advance, e-mail with an attached file is transmitted to the e-mail address, and the printer performs printing according to the image data of the attached file. More specifically, the printer requests an e-mail address of a server in printer initial setting, and acquires and holds a unique e-mail address. The mobile terminal device used by the user transmits a file to be printed to the e-mail address by attaching it to e-mail. The server holds a table for associating a printer with an e-mail address. Upon receiving e-mail destined to an e-mail address, the server looks up the table to specify a printer as a print output destination. As described above, in the conventional print system, the server side and printer side need to have the above arrangement.

Japanese Patent Laid-Open No. 2001-312392 proposes a technique in which a dedicated adaptor is arranged between a server and a printer to print a file attached to e-mail sent from a mobile terminal device. In a print system described in Japanese Patent Laid-Open No. 2001-312392, therefore, it is necessary to add a dedicated device other than a server and printer. Furthermore, Japanese Patent Laid-Open No. 2006-323456 proposes a technique in which various print settings (to be referred to as print option settings hereinafter) from a mobile terminal device are described in e-mail, and analyzed by an image processing apparatus, thereby executing printing.

The above conventional techniques, however, have the following problems. In, for example, Japanese Patent Laid-Open No. 2004-220606, it is necessary to provide a printer with an arrangement for requesting an e-mail address of a server. Furthermore, the server needs to have an arrangement for managing a table for asssociating an e-mail address with an output destination printer. In Japanese Patent Laid-Open No. 2001-312392, a device other than a server and printer is required. That is, it is necessary to add an arrangement for implementing the above conventional technique to both the printer side and server side, or another device. In Japanese Patent Laid-Open No. 2006-323456, if print option settings are described in mail, and the mail is transmitted, there are many setting items, thereby considerably deteriorating the user operability.

### SUMMARY OF THE INVENTION

The present invention enables realization of an information processing apparatus which enables a mobile terminal device to send a print instruction to a printer without adding a dedicated arrangement to the printer, a control method for the information processing apparatus, and a storage medium.

One aspect of the present invention provides an information processing apparatus communicable with a mobile terminal device and an image forming apparatus, comprising: a reception unit configured to receive e-mail from the mobile terminal device; an analysis unit configured to analyze the e-mail received by the reception unit; and a control unit configured to, if the e-mail has an attached file and a print instruction is described in a body field of the e-mail in accordance with an analysis result of the analysis unit, transmit image data attached to the e-mail with transmitting a print instruction, to an image forming apparatus designated in a subject field or the body field of the e-mail.

Another aspect of the present invention provides a control method for an information processing apparatus communicable with a mobile terminal device and an image forming apparatus, comprising: receiving, by a reception unit, e-mail from the mobile terminal device; analyzing, by an analysis unit, the e-mail received in the receiving; and transmitting, by a control unit, if the e-mail has an attached file and a print instruction is described in a body field of the e-mail in accordance with an analysis result in the analyzing, image data attached to the e-mail with transmitting a print instruction, to an image forming apparatus designated in a subject field or the body field of the e-mail.

Further features of the present invention will become apparent from the following description of exemplary embodiments with reference to the attached drawings.

### BRIEF DESCRIPTION OF THE DRAWINGS

FIG. 1 is a block diagram showing the overall configuration of a print system according to an embodiment;

FIG. 2 is a block diagram showing the hardware arrangement of an access point according to the embodiment;

FIG. 3 is a block diagram showing the hardware arrangement of a PC (mail server or print server) according to the embodiment;

FIG. 4 is a block diagram showing the hardware arrangement of a printer according to the embodiment;

FIG. 5 is a block diagram for explaining transmission/reception of e-mail with respect to the mail server according to the embodiment;

FIG. 6 is a flowchart illustrating the procedure of the whole print system according to the embodiment;

FIG. 7 is a flowchart illustrating the procedure of the print server according to the embodiment;

FIG. 8 is a table for associating an extension with an application according to the embodiment;

FIG. 9 is a table for associating a printer driver with a printer name according to the embodiment;

FIG. 10 is a block diagram showing the overall configuration of a print system according to another embodiment;

FIG. 11 is a block diagram showing the overall configuration of a print system according to still another embodiment;

FIG. 12 is a view showing an e-mail transmission screen for sending a print option setting request from a mobile terminal device according to the embodiment;

FIG. 13 is a view showing an e-mail reception screen when the print server transmits print options to the mobile terminal device according to the embodiment;

FIG. 14 is a view showing the e-mail transmission screen of the mobile terminal device which sends a reply to the e-mail shown in FIG. 13;

FIG. 15 is a table showing the settings of each printer, which are transmitted to the mobile terminal device according to the embodiment; and

FIG. 16 is a table for performing association of each mail message according to the embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

<Configuration of Print System>

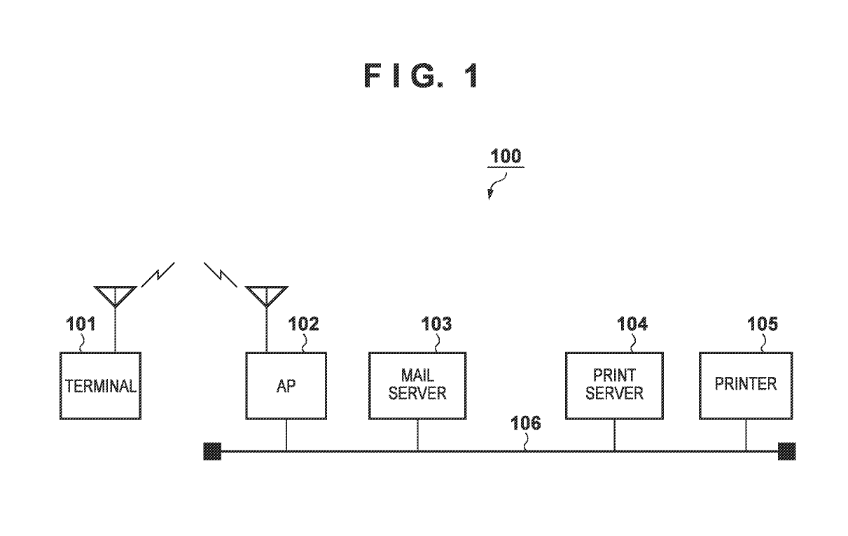

An embodiment of the present invention will be described below with reference to FIGS. 1 to 9 and 12 to 16. The overall configuration of a print system according to the embodiment will be explained first with reference to FIG. 1. A print system 100 includes a mobile terminal device 101, an access point 102, a mail server 103, a print server 104, and a printer 105. A wired LAN (Local Area Network) 106 connects the AP 102, mail server 103, print server 104, and printer 105 by wired connection using an Ethernet® cable (LAN cable), thereby establishing the network. Note that the present invention is not limited to the apparatuses or the number of apparatuses of the print system 100 shown in FIG. 1, and is applicable to various modes.

The mobile terminal device 101 is portable, and incorporates an operating system (to be referred to as an “OS” hereinafter) on which various application software programs can operate. In the present invention, the mobile terminal device 101 can transmit e-mail to the printer 105 through wireless communication using e-mail software as one application software program.

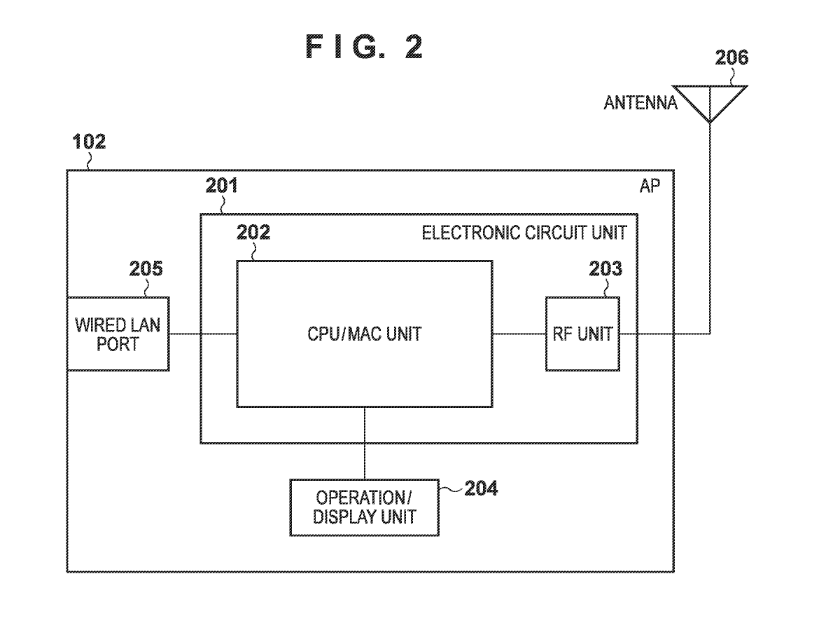

The access point (to be referred to as an “AP” hereinafter) 102 is wirelessly connected with the mobile terminal device 101, and enables the mobile terminal device 101 to connect the wired LAN through wireless communication. Details of an internal arrangement will be described later with reference to FIG. 2.

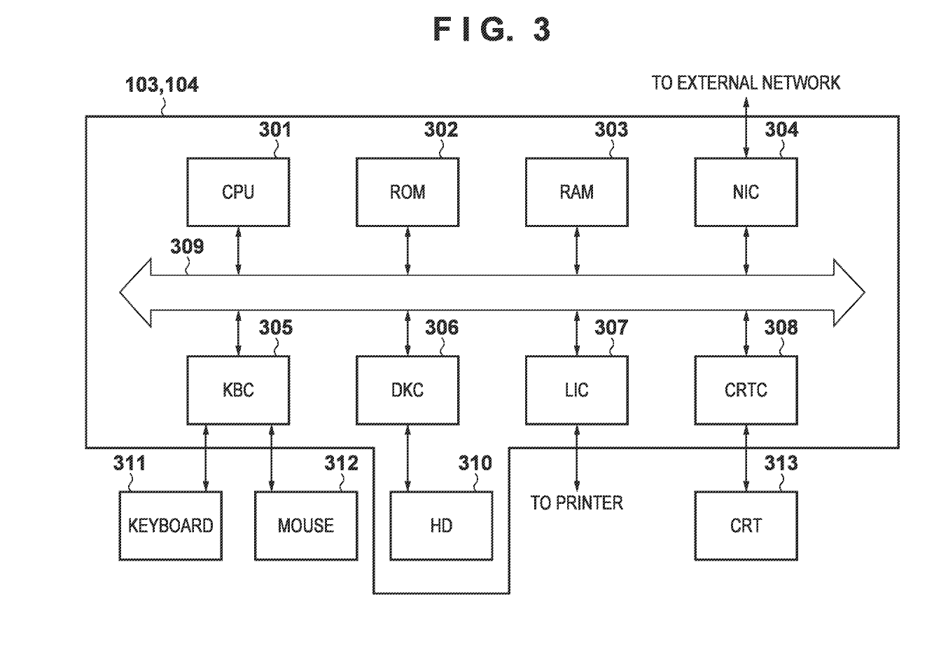

The mail server 103 has the same internal arrangement as that of a general personal computer (to be referred to as a “PC” hereinafter). The function of the mail server is implemented by installing mail server software onto the mail server 103 and operating it. Details of the internal arrangement will be described later with reference to FIG. 3. The mail server 103 holds e-mail transmitted from the mobile terminal device 101. The print server 104 as an example of an information processing apparatus also has the same internal arrangement as that of a general PC, similarly to the mail server 103. Similarly, details of the internal arrangement will be described later with reference to FIG. 3. The print driver software of each printer connected with the wired LAN 106 has been installed onto the print server 104. The printer 105 prints print data (image data) on a paper sheet in response to a print instruction from the print server 104.

<Arrangement of Access Point>

An example of the hardware arrangement of the access point 102 according to the embodiment will be described with reference to FIG. 2. The access point 102 enables an apparatus (for example, the mobile terminal device 101 shown in FIG. 1) connected with a wireless communication network and a wired communication network (for example, the wired LAN 106 shown in FIG. 1) to communicate with each other.

The AP 102 includes an electronic circuit unit 201, an operation/display unit 204, and a wired LAN port 205. The wired LAN port 205 has a connector connectable with an Ethernet® cable for connecting to the wired LAN 106. The operation/display unit 204 is mainly formed by, for example, an LED and switch. The operation/display unit 204 displays the state of the main body of the AP 102 and that of each port. The operation/display unit 204 also includes a switch for readily connecting to a wireless LAN. The AP 102 also has a security function for secure wireless LAN connection.

The electronic circuit unit 201 includes a CPU/MAC unit 202 and a radio frequency transmission/reception unit (to be referred to as an “RF (Radio Frequency)” hereinafter) 203. The CPU/MAC unit 202 includes a CPU (not shown) and a MAC (Media Access Control) (not shown). The CPU includes devices such as a processor and memory. The above devices are interconnected by a bus (not shown). The MAC includes a wireless communication part and a wired communication part. An antenna 206 for transmitting/receiving a radio wave is attached to the RF unit 203. The CPU/MAC unit 202 is connected with the operation/display unit 204, RF unit 203, and wired LAN port 205.

FIG. 2 also shows an environment in which the AP 102 is used, together with the arrangement of the AP 102. The AP 102 is connected with the wired LAN 106 of FIG. 1 as an example of a wired LAN via the Ethernet® cable (not shown). One end of the Ethernet® cable is connected with the wired LAN port 205, and the other end is connected with a network hub (not shown).

<Arrangement of Mail Server and Print Server>

The internal hardware arrangement of the mail server 103 or print server 104 will be described with reference to FIG. 3. The mail server 103 or the print server 104 as an example of an information processing apparatus is connected with a well-known CPU 301, ROM 302, RAM 303, and network interface controller (NIC) 304 via a bus 309. Furthermore, a keyboard controller (KBC) 305, a disk controller (DKC) 306, a local interface controller (LIC) 307, and a CRT controller (CRTC) 308 are also connected via the bus 309.

An Ethernet® cable indicated by the wired LAN 106 shown in FIG. 1 is connected with the network interface controller (NIC) 304. A keyboard 311 and a mouse 312 are connected with the keyboard controller (KBC) 305. A hard disk (HD) 310 is connected with the disk controller (DKC) 306. A peripheral is connected with the local interface controller (LIC) 307 via a local interface such as USB. A CRT display 313 is connected with the CRT controller (CRTC) 308. The ROM 302 stores a basic I/O program, an operating system (OS), and the like. The CPU 301 manages and executes an application program based on execution of the OS.

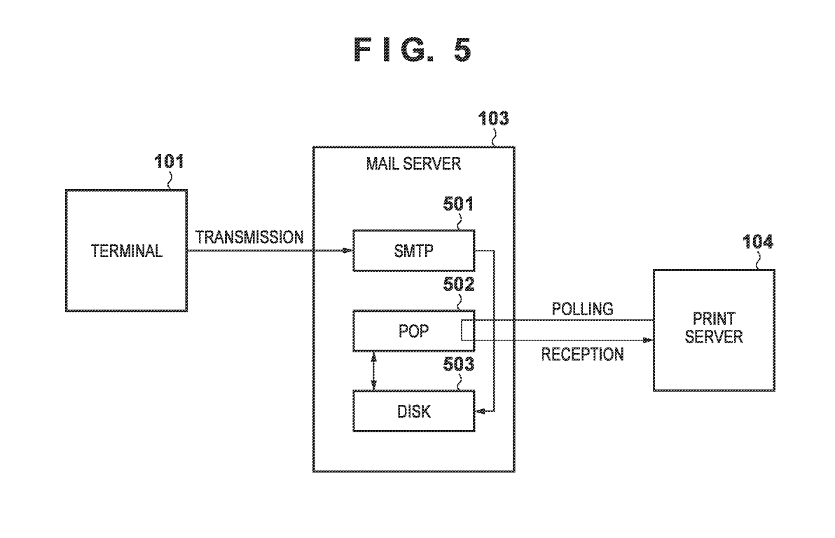

The hard disk (HD) 310 of the print server 104 stores a mobile terminal print application and various application programs of the present invention, a printer driver, and a print option table for each printer used when a terminal instructs e-mail printing. Furthermore, the HD 310 stores a table for associating, with each other, mail with an attached file for which a print option setting request has been made, mail from the print server as a reply to the request, and mail for which the user has designated settings. The print server 104 has a mail client function and a printer control function, and uses them to implement a function of printing a file attached to mail. The mail server function of the mail server 103 will be described later with reference to FIG. 5.

<Arrangement of Printer>

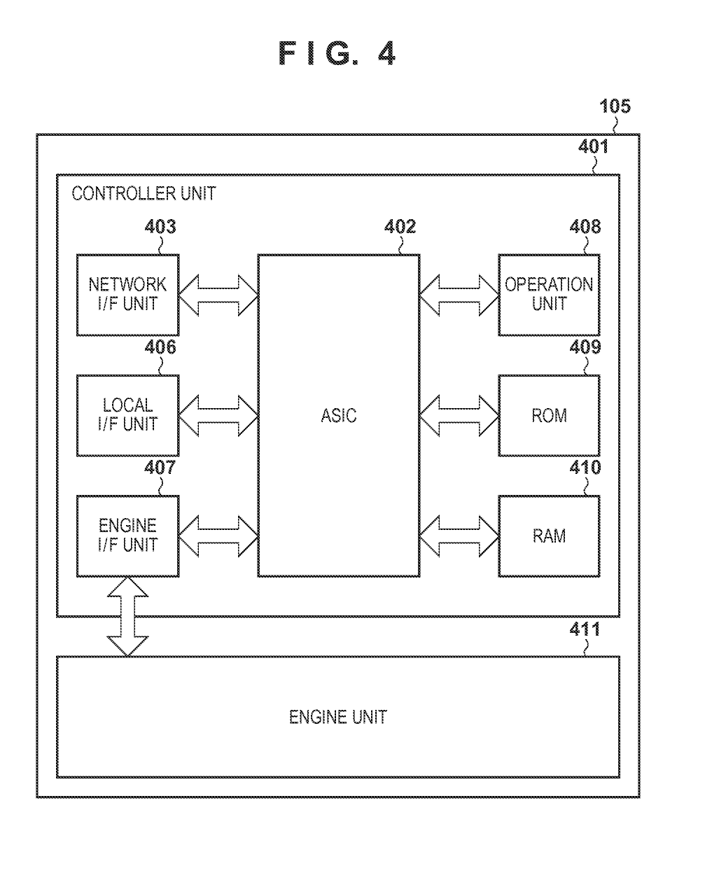

An example of the hardware arrangement of the printer 105 as an example of an image forming apparatus will be described with reference to FIG. 4. The printer 105 includes a controller unit 401 and an engine unit 411. The controller unit 401 includes an ASIC 402, a network I/F unit 403, a local I/F unit 406, an engine I/F unit 407, an operation unit 408, a ROM 409, and a RAM 410.

The controller unit 401 processes print data received via the network I/F unit 403 and local I/F unit 406. The ASIC 402 incorporates a CPU, and mainly executes processing of passing print data to the engine unit 411. The operation unit 408 notifies the user of the status of the printer, and accepts an operation input from the user. The ROM 409 stores a control program. The RAM 410 serves as a work area for the control program, or an image expansion area when the print data is processed. The network I/F unit 403 and local I/F unit 406 transmit/receive data to/from a PC via an external interface. Examples of the external interface are Ethernet® and USB interfaces. The engine I/F unit 407 sends processed print data to the engine unit 411. The engine unit 411 prints, onto a paper sheet, the print data from the controller unit 401.

<E-Mail>

Transmission/reception of e-mail with respect to the mail server 103 will be described with reference to FIG. 5. In the mail server 103, an SMTP (Simple Mail Transfer Protocol) server 501 and a POP (Post Office Protocol) server 502 operate, and respectively perform completely different operations. The SMTP server 501 controls, for example, communication with the mobile terminal device 101 through wireless communication. On the other hand, the POP server 502 controls, for example, communication with the print server 104 via the wired LAN 106.

The mobile terminal device 101 uses the internal e-mail software to transmit e-mail. The mail server 103 connected with the wired LAN receives the transmitted e-mail via the AP 102. At this time, the e-mail software of the mobile terminal device 101 designates the predetermined mail address (destination) of the mail server 103. For example, USER@mailprint.xx.jp is designated. Upon receiving the e-mail, the mail server 103 stores the e-mail in its own hard disk 503, and terminates the operation.

After that, according to an instruction from a mobile cooperative print application according to the embodiment, the print server 104 regularly polls the POP server 502 of the mail server 103 to check whether e-mail has been received. At this time, the print server 104 designates the predefined mail address (destination). The mobile cooperative print application according to the embodiment can arbitrarily set a polling interval.

The POP server 502 of the mail server 103 requests a user name and password for access from the print server 104. When the user name and password are verified, the POP server 502 checks accumulated received mail messages, and returns information about the presence/absence of e-mail destined to the print server 104. If the POP server 502 holds received e-mail destined to the print server 104, it passes it to the print server 104, and terminates the operation. Note that the polling operation of the mobile terminal device 101 is the same as that of the print server 104.

<Print Processing in Print System>

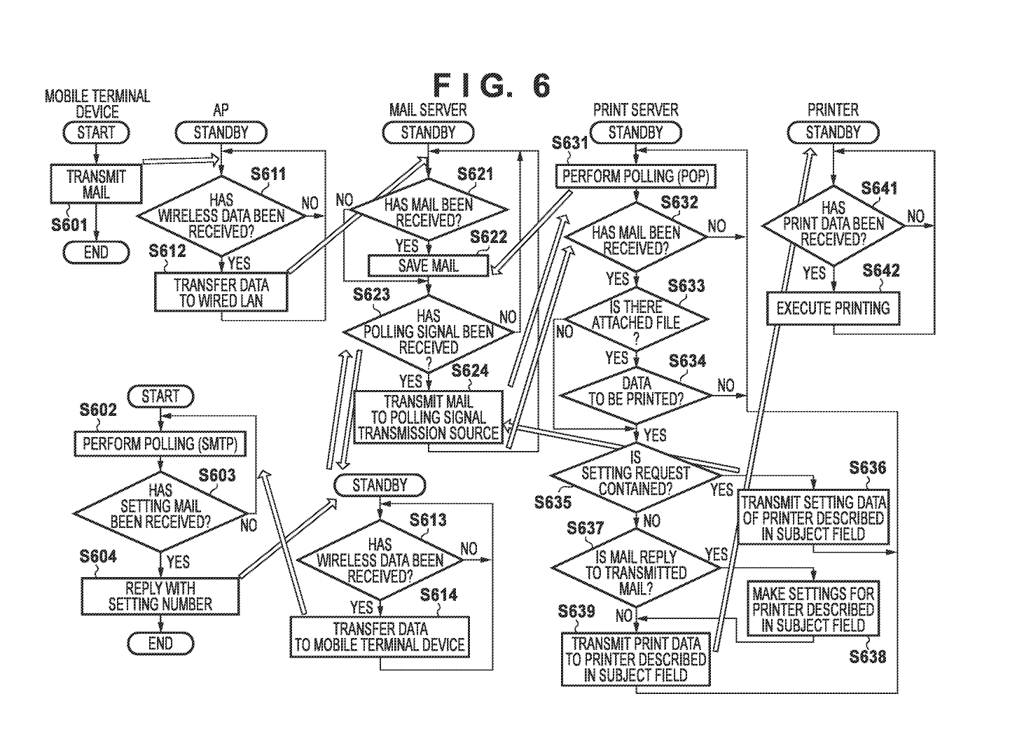

The processing procedure of the whole print system 100 from when the mobile terminal device 101 transmits e-mail to set print options until the printer 105 prints an attached file will be described with reference to FIG. 6.

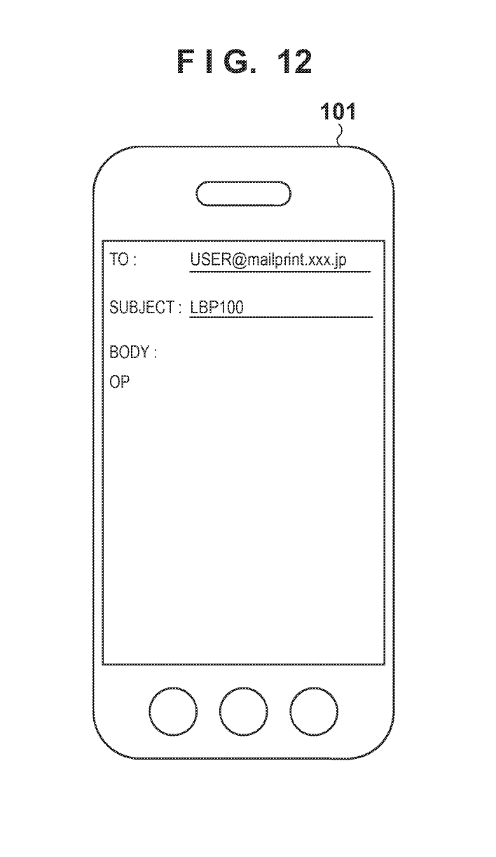

In step S601, the e-mail software of the mobile terminal device 101 held by the user attaches a file to be printed, and describes a print option setting request in a body field, thereby transmitting the thus obtained e-mail. FIG. 12 shows the transmission screen of the e-mail software of the mobile terminal device 101. As shown in FIG. 12, USER@mailprint.xxx.jp is described in a recipient field, and LBP100 is described in a subject field. The printer name of a printer from which the user wants to print out the file is described in the subject field. If the printer name is described in the body field, the same function is implemented. Furthermore, letters indicating a print setting request are described in the body field. In the embodiment, for example”, “OP” is described. This description is merely an example, and is not intended to limit the present invention. As described above, the e-mail is transmitted via the wireless LAN.

Referring back to FIG. 6, in step S611, the access point 102 receives, as wireless data, the e-mail from the mobile terminal device 101 via the wireless LAN. More specifically, a wireless signal is input from the antenna 206. The RF unit 203 of the access point 102 converts the wireless signal from an analog signal to a digital signal. At the subsequent stage, the CPU/MAC unit 202 analyzes the digital signal to obtain a recipient and a path, and then the e-mail is transmitted onto the wired LAN 106 through the wired LAN port 205. More specifically, in step S612, the AP 102 transmits the e-mail to the mail server 103 (the SMTP server 501 of FIG. 5) via the wired LAN.

In step S621, the mail server 103 receives the e-mail, and stores it in the hard disk 310 of FIG. 3 together with an attached file. On the other hand, in step S631, the print server 104 polls the POP server of the mail server 103 at regular intervals. This operation has been described above with reference to FIG. 5. If the print server 104 checks mail (performs polling), the mail server 103 determines in step S623 that a polling signal has been received, and transmits a corresponding e-mail and an attached file to the print server 104 as a polling signal transmission source in step S624.

In step S632, the print server 104 determines whether e-mail has been received. If e-mail has been received, the process advances to step S633, in which it is determined based on the analysis result of analysis of the e-mail whether there is an attached file. If there is an attached file, the process advances to step S634, in which the print server 104 analyzes the attached file, and determines whether the attached file of the received e-mail is print data. If the attached file is print data, the process advances to step S635; otherwise, the process returns to step S631.

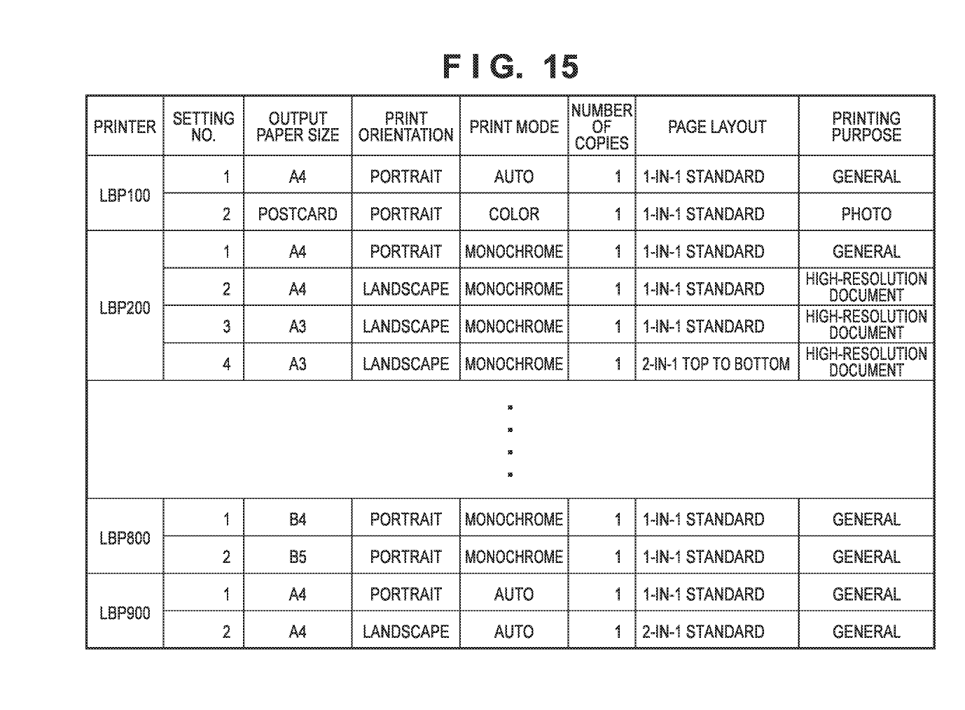

In step S635, the print server 104 performs analysis to determine whether the body field of the e-mail contains a print option setting request. If the request is contained, the process advances to step S636, in which the print server 104 reads out, from a table (to be described later), setting data which are registered in the table in association with the printer described in the subject field of the e-mail. The print server 104 then describes the readout setting data in the body field of e-mail, and replies with it as a response to the e-mail from the mobile terminal device 101, thereby returning to step S631. That is, the print server 104 transmits reply mail to the e-mail from the mobile terminal device 101. The print server 104 holds, in advance, in the HD (setting storage unit) 310, the settings of each of a plurality of printers connected via the network (wired LAN 106) as a table shown in FIG. 15. As shown in FIG. 15, a plurality of settings are registered in advance for each printer. The print server 104 acquires settings corresponding to the printer described in the subject field of the e-mail from the table in step S636, and describes the acquired settings in the body field of the e-mail. In step S636, the print server 104 stores, in association with each other, the reply e-mail and the e-mail with an attached file sent from the mail server 103. For example, the print server 104 assigns a unique message ID to the mail header portion of the reply e-mail, associates it with print data and the e-mail with the attached file sent from the mail server 103, and saves the thus obtained data within the HD 310 of the print server 104. Alternatively, the print server 104 associates the message ID with a reception time, an address, a subject (printer name), a transmission time, a sender address, and the like, and saves the thus obtained data.

The mail server 103 receives the mail in step S621, saves it in step S622, and stands by for reception of a polling signal from the mobile terminal device 101 in step S623. In step S602, the mobile terminal device 101 performs polling, and accesses the mail server 103 via the access point 102. Upon receiving a polling signal from the mobile terminal device 101, the mail server 103 transmits new mail destined to the mobile terminal device 101 within itself in step S624. Upon receiving the new mail, the access point 102 determines in step S613 that wireless data has been received, and transfers the wireless data to the mobile terminal device 101 in step S614.

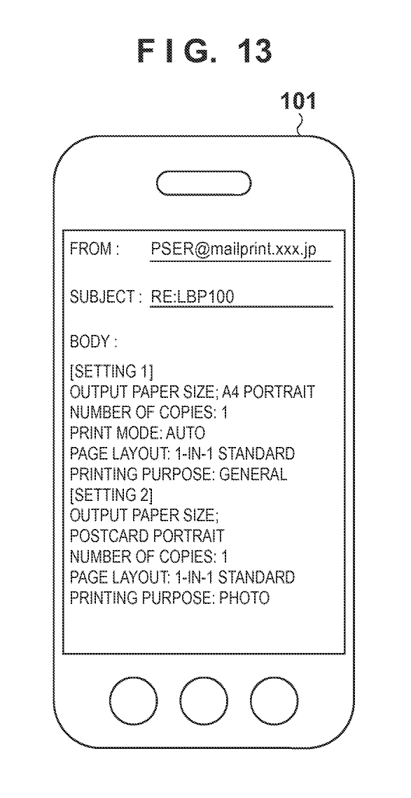

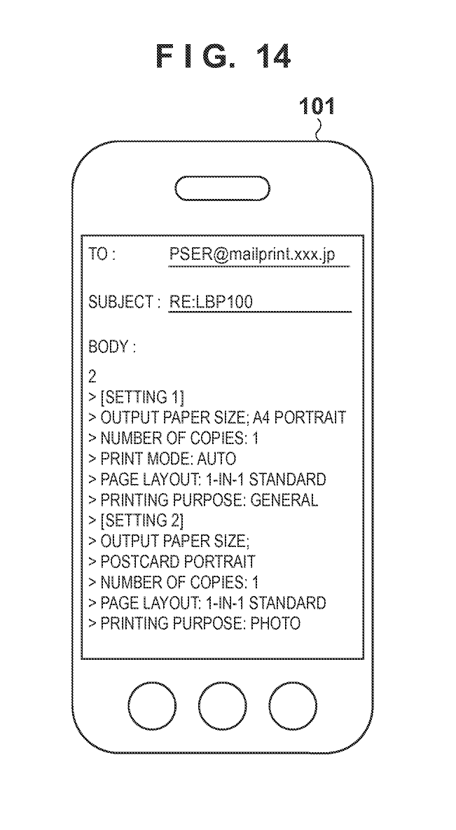

FIG. 13 shows a reception screen for mail sent from the print server 104 to the mobile terminal device 101. Assume that the address of the print server 104 is, for example, “PSER@mailprint.xxx.jp”. In the example shown in FIG. 13, “setting 1” and “setting 2” are displayed, and the user can select one of the settings to be applied to printing. Upon receiving the e-mail containing print option setting data of the printer, the mobile terminal device 101 selects, from the setting data, a setting to be applied to printing according to a user input, describes the number in the body field of e-mail, and replies with the e-mail in step S604. FIG. 14 shows an example of a transmission screen. In the example of FIG. 14, “setting 2” has been selected.

In steps S611 and S612, the access point 102 transfers the mail to the mail server 103. In response to the polling operation of the print server 104 in steps S631 and S632, the mail server 103 transmits the mail to the print server 104. The print server 104 determines in step S635 whether the mail contains a setting request. Since there is no attached file or setting request in the mail, the process advances to step S637. In step S637, the print server 104 determines whether the mail is a reply to the e-mail transmitted by the print server 104. Since the mail is a reply, the process advances to step S638, in which print options are set in the printer described in the subject field, that is, LBP100 in this example. The process then advances to step S639. If the mail is not a reply to the transmitted e-mail, the process advances to step S639 without executing the processing in step S638.

In step S639, the print server 104 searches the HD 310 within the print server 104 for print data and mail with an attached file associated with the mail, and transmits the print data to the printer (LBP100) set with the print options. The printer 105 receives the print data in step S641, and executes printing according to the settings in step S642.

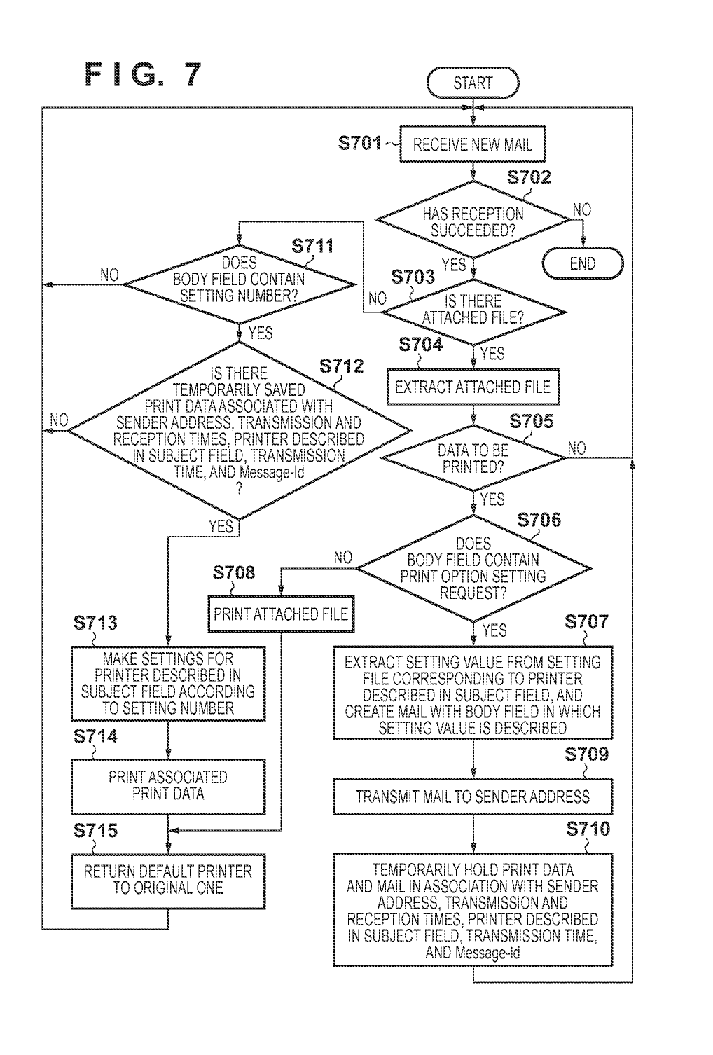

Note that data to be processed will be referred to as an “attached file” until the print server 104 analyzes the file in step S633. After the print server 104 performs analysis in step S633, data expanded to that to be printed will be referred to as “print data”. The processing in steps S631 to S639 by the print server 104 will be described in detail later with reference to FIG. 7.

<Processing of Print Server 104>

The processing in steps S631 to S639 executed by the print server 104 will be described in detail with reference to FIG. 7. The processing to be explained below is implemented when the CPU 301 of the print server 104 reads out, into the RAM 303, a control program stored in the ROM 302 or HD 310 in advance, and executes it.

In step S701, the CPU 301 receives e-mail from the mail server 103 by polling the POP server 502. In step S702, the CPU 301 determines whether the e-mail has been successfully received. If the e-mail has not been successfully received, the process ends; otherwise, the process advances to step S703, in which the CPU 301 determines whether there is an attached file. If there is an attached file, the process advances to step S704, in which the CPU 301 extracts the attached file. After that, the process advances to step S705, in which the CPU 301 determines whether the extracted file is data to be printed. If the extracted file is not data to be printed, the process returns to step S701 to stand by for next new mail. If the extracted file is printable data, the CPU 301 controls the DKC 306 via the bus 309 to store the data in the HD 310. In step S706, the CPU 301 analyzes the received mail to determine whether the body field contains a print option setting request (for example, a character string “OP”) for the printer 105.

If the body field contains print option settings, the process advances to step S707, in which the CPU 301 extracts the setting file of a printer described in a subject field, which has been saved in the HD 310, creates reply mail, and describes the settings in the body field of the reply mail, as shown in FIG. 13. In step S709, the CPU 301 transmits the mail created in step S707. Furthermore, in step S710, the CPU 301 associates the mail with the sender address of the mail containing the print option setting request, the reception time, the printer name described in the subject field, and the transmission time of the reply mail, and stores it in the HD 310. Similarly, the CPU 301 also associates the print data attached to the mail, and stores it in the HD 310. Note that if no reply to the mail transmitted in step S709 is received even after a given period of time elapses, printing may be executed according to corresponding print data with default settings.

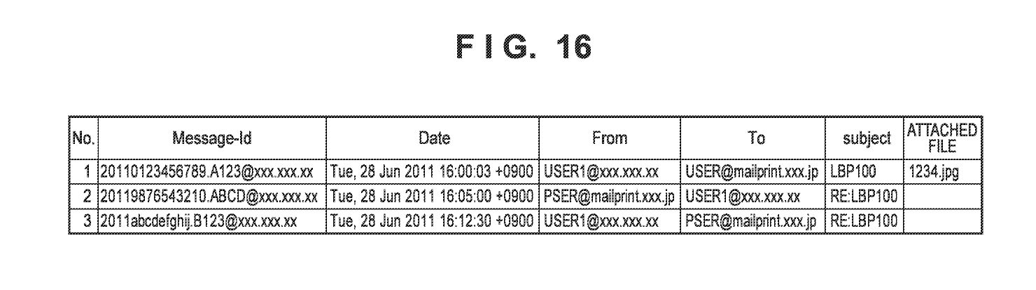

FIG. 16 shows an example of a table showing association of the mail. In the example, “Message-Id” unique to each mail message, “Date”, “From”, “To”, “Subject”, and the presence/absence of “attached file” are associated with each other. For example, in column No. 1 of the table, the parameters of mail with an attached file (1234.jpg) are stored in association with each other. A date/time when the mail is received is defined in “Date”. The sender of the mail is defined in “From”. The recipient of the mail is defined in “To”. The subject of the mail is defined in “Subject”. If there is a file attached to the mail, the file name of the file is defined in “attached file”.

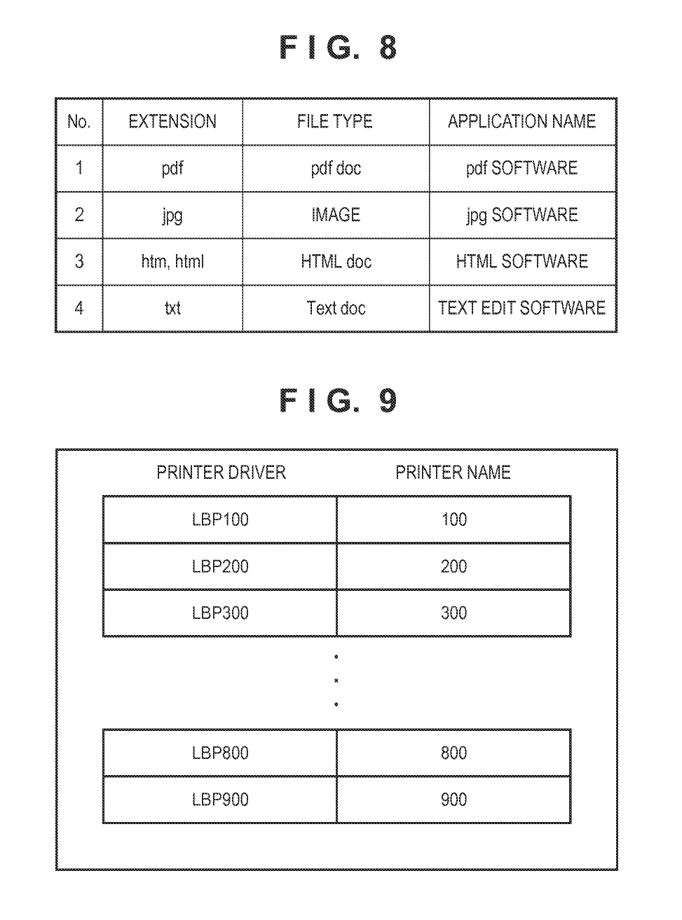

Referring back to FIG. 7, if it is determined in step S706 that there is no print option setting request, the process advances to step S708, in which the CPU 301 reads out the print data saved in the HD 310, and starts an application corresponding to the file extension of the print data. The CPU 301 uses the print function of the application to cause the printer described in the subject field to execute printing. A table shown in FIG. 8 is used to determine which application within the print server 104 corresponds to the extension of a file attached to e-mail. The processing in step S708 is implemented by starting the print function of an application suitable for a file extension. If, for example, the file extension of print data is “pdf”, the CPU 301 starts “pdf software” as a corresponding application, and uses the print function of the pdf software to cause a corresponding printer to execute printing (send a print instruction). The print server 104, therefore, stores applications defined in the table shown in FIG. 8 in the HD (application storage unit) 310 in advance. If the printing ends, the process advances to step S715, in which the CPU 301 returns the default printer from the printer described in the subject field to an original one.

On the other hand, if it is determined in step S703 that there is no attached file, the process advances to step S711, in which the CPU 301 determines whether a print option setting number is described in the body field. If there is no print option setting number, the process returns to step S701, the CPU 301 stands by for reception of new mail. On the other hand, if there is a setting number, the process advances to step S712, in which the CPU 301 determines whether the HD 310 stores print data associated with the received mail. If there is no associated print data, the process returns to step S701, in which the CPU 301 stands by for new mail. If there is associated print data, the process advances to step S713, in which the CPU 301 reflects settings on the printer described in the subject field according to the print option setting number. For example, settings with setting No. 2 of the printer of LBP 100 shown in FIG. 15 are made. After that, in step S714, the CPU 301 transmits the associated print data to the printer described in the subject field, and causes the printer to execute printing. After completion of the printing, in step S715, the CPU 301 returns the default printer from the printer described in the subject field to the original one, similarly to step S708. If even though a print option setting number has been described, the described number has an error in writing, or no reply mail is received before a predetermined period of time elapses, the default settings may be adopted. A case in which the described number has an error in writing indicates a case in which No. 3 is described although there are only two choices of No. 1 and No. 2. Furthermore, the mobile terminal device 101 may be notified that there is an error in writing.

Note that a table for a printer driver and “printer name” in the subject field of e-mail may be, for example, a table shown in FIG. 9. If a new printer is connected with the wired LAN 106 of FIG. 1 or the local interface of the print server 104, the CPU 301 of the print server 104 adds information about the printer driver and printer name of the printer to the table.

As described above, in the print system according to the embodiment, the mobile terminal device 101 can readily set print options in a printer to print out data by adding the above-described characteristic arrangement to only the printer server side without providing a dedicated arrangement to the printer. Since even the printer name of a printer newly added to the print system can be readily recognized, a decrease in load to user operations can be expected.

### Other Embodiments

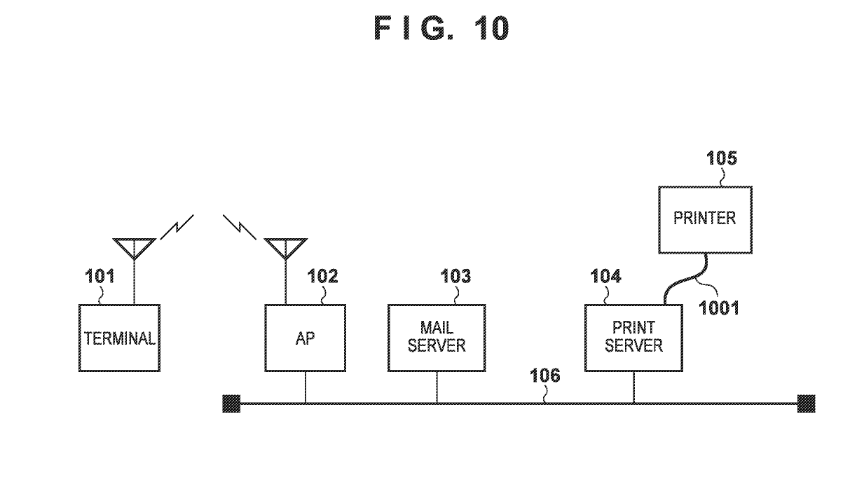

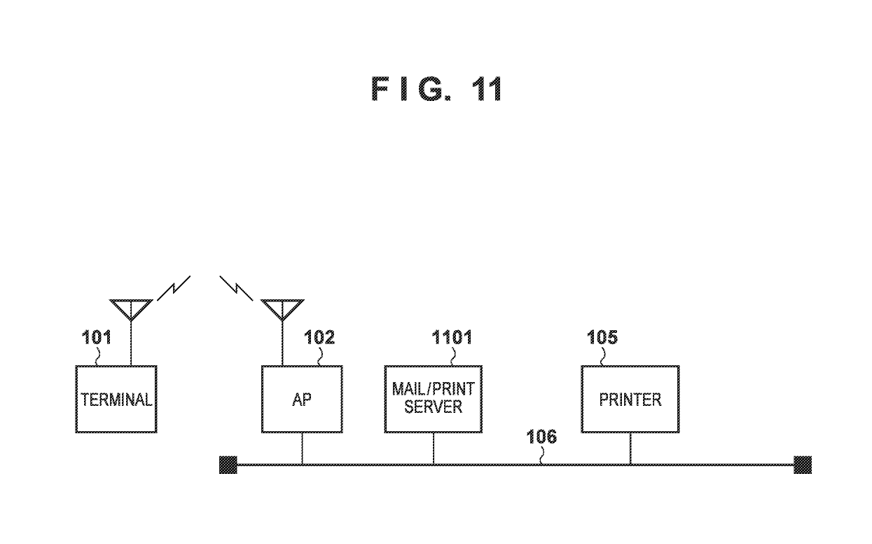

The present invention is not limited to the above-described embodiment, and various modifications are possible. FIGS. 10 and 11 respectively show modifications. The connection method of a printer 105 in the modification shown in FIG. 10 is different from that in the above-described embodiment. In the above-described embodiment, the printer 105 is directly connected with the wired LAN 106. A printer having only a local interface can be connected with an LIC 307 of a print server 104 by, for example, a USB cable 1001, as shown in FIG. 10. Note that the above arrangement enables to implement a function equivalent to that in the above embodiment, as a matter of course.

On the other hand, the modification in FIG. 11 is different from the above-described embodiment in that one PC 1101 forms the mail server 103 and print server 104. Such an arrangement is possible since the mail server function and print server function are basically implemented by software. Note that the above arrangement enables to implement a function equivalent to that in the above embodiment, as a matter of course.

Although in the above-described embodiment, the communication unit of the mobile terminal device 101 transmits e-mail via the wireless LAN, e-mail may be transmitted via a mobile telephone network. Furthermore, the mobile terminal device 101 may attach a plurality of files to e-mail, and the present invention is not limited to the description of the above embodiment.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-006556 filed on Jan. 16, 2012, which is hereby incorporated by reference herein in its entirety.

What is claimed is:

1. An information processing apparatus communicable with a mobile terminal device and an image forming apparatus, comprising:
a reception unit configured to receive e-mail from the mobile terminal device;
an analysis unit configured to analyze the e-mail received by the reception unit; and
a control unit configured to, if the e-mail has an attached file and a print instruction is described in a body field of the e-mail in accordance with an analysis result of the analysis unit, transmit image data attached to the e-mail with transmitting a print instruction, to an image forming apparatus designated in a subject field or the body field of the e-mail.

2. The apparatus according to claim 1, further comprising
a setting storage unit configured to store, in advance, a plurality of settings associated with image formation of each of a plurality of image forming apparatuses connected to a network including the information processing apparatus,
wherein if the analysis result of the analysis unit indicates that the e-mail has an attached file and no print instruction is described in the body field of the e-mail, the control unit acquires, from the setting storage unit, a plurality of settings for the image forming apparatus designated in the e-mail, describes the plurality of acquired settings in a body field of e-mail, and transmits the e-mail as a response to the e-mail received by the reception unit.

3. The apparatus according to claim 2, wherein if the analysis result of the analysis unit indicates that the e-mail has no attached file and one of the plurality of settings is described in the body field of the e-mail, the control unit reflects the setting, and transmits image data attached to the e-mail with transmitting a print instruction, to the image forming apparatus designated in the subject field or the body field of the e-mail.

4. The apparatus according to claim 3, wherein if one of the plurality of settings described in the body field of the e-mail from the mobile terminal device has an error in writing, or the e-mail is not received before a predetermined period of time elapses, the control unit instructs printing with a default setting.

5. The apparatus according to claim 3, wherein if one of the plurality of settings described in the body field of the e-mail from the mobile terminal device has an error in writing, the control unit notifies the mobile terminal device that there is the error in writing.

6. The apparatus according to claim 1, further comprising
an application storage unit configured to store a plurality of application software programs each corresponding to a file extension of image data attached to the e-mail,
wherein the control unit uses the application storage unit to start an application corresponding to a file extension of image data for which printing is instructed, and sends a print instruction through the started application.

7. The apparatus according to claim 1, wherein the information processing apparatus performs communication with the mobile terminal device through wireless connection, and performs communication with the image forming apparatus through wired connection.

8. The apparatus according to claim 7, wherein the information processing apparatus transmits/receives e-mail from the mobile terminal device via a mail server for transmitting/receiving the e-mail.

9. The apparatus according to claim 8, wherein the information processing apparatus has a function of the mail server, and transmits/receives the e-mail to/from the mobile terminal apparatus without the intervention of the mail server.

10. The apparatus according to claim 1, wherein the information processing apparatus is connected with the image forming apparatus by wired connection using a LAN cable or a USB cable.

11. A control method for an information processing apparatus communicable with a mobile terminal device and an image forming apparatus, comprising:
receiving, by a reception unit, e-mail from the mobile terminal device;
analyzing, by an analysis unit, the e-mail received in the receiving; and
transmitting, by a control unit, if the e-mail has an attached file and a print instruction is described in a body field of the e-mail in accordance with an analysis result in the analyzing, image data attached to the e-mail with transmitting a print instruction, to an image forming apparatus designated in a subject field or the body field of the e-mail.

12. A computer-readable storage medium storing a computer program for causing a computer to execute each step of a control method for an information processing apparatus according to claim 11.
